(19) United States
(12) Patent Application Publication
(10) Pub. No.: US 2013/0114826 A1
(43) Pub. Date: May 9, 2013

(54) LIGHT BULB HOLDER MODULE WITH BUILT-IN SPEAKER

(71) Applicant: Nai-Chien CHANG, New Taipei City (TW)

(72) Inventor: Nai-Chien CHANG, New Taipei City (TW)

(21) Appl. No.: 13/673,660

(22) Filed: Nov. 9, 2012

(30) Foreign Application Priority Data
Nov. 9, 2011 (TW) 100221168

(51) Int. Cl. H04B 3/00

(52) U.S. Cl. 381/77

(57) ABSTRACT

A light bulb holder module with a built-in speaker is embedded into a light bulb slot. The light bulb holder module includes a light bulb holder, a control unit, a first electronic switch, a second electronic switch, a wireless transceiver unit, and a speaker. Also, a light bulb is installed on the light bulb holder. The wireless transceiver unit receives an external control signal and transmits the control signal to the control unit. The control unit turns on or turns off the first electronic switch and the second electronic switch according to contents of the control signal, thus lightening or extinguishing the light bulb or turning on or turning off the speaker. In addition, the wireless transceiver unit also receives external audio signals and transmits the audio signals to the control unit to be processed. The processed audio signals are played by the speaker.

This application is based on and claims the benefit of Taiwan Application No. 100221168 filed Nov. 09, 2011 the entire disclosure of which is incorporated by reference herein.

### BACKGROUND

1. Technical Field

The present disclosure relates generally to a light bulb holder module, and more particularly to a light bulb holder module that can wirelessly receive audio signals and play the received audio signals.

2. Description of Related Art

With the development of the semiconductor industry, various electronic devices are prevalent. Also, the electronic devices have powerful functions, features, and abilities which are built therein. Accordingly, the electronic devices cannot be separated from the scope of entertainment for users.

As far as the audiovisual entertainment, the television and the speaker are the most important and essential electronic devices. The sound quality and location of the speaker are particularly important as well as proper size and higher resolution of the television. If the speaker doesn't be placed on a good location, such as too far away from the user or obstructions between the user and the speaker, the user cannot obtain good audio quality. Hence, how to place the speaker in the correct location is considerable for the user.

In general, the least affected from obstructions in a residential location is the ceiling. For an audio-visual room, the best location of placing the speaker is around the ceiling. Once the speaker is placed on the ceiling, however, the audio source wires and power wires are indispensable for connecting the speaker, the power source, and playing audio files of the electronic device. Hence, the problem of excessive and cluttered wires and poor visual perception due to the exposed wires would cause the user trouble.

Accordingly, how to place the speaker in the correct location and integrate the speaker with other devices for overcoming the problem of excessive and cluttered wires and poor visual perception is the direction of research and development of the present disclosure.

### SUMMARY

An object of the present disclosure is to provide a light bulb holder module with a built-in speaker. The light bulb holder module can wirelessly receive audio signals transmitted from an external electronic apparatus and the received audio signals are played by the built-in speaker.

Another object of the present disclosure is to provide a light bulb holder module with a built-in speaker. A control unit inside the light bulb holder module is used to directly execute and decode audio files and the processed audio files are played by the built-in speaker.

In order to achieve the above-mentioned object, the light bulb holder module is embedded into a light bulb slot. The light bulb holder module includes a light bulb holder, a control unit, a first electronic switch, a second electronic switch, a wireless transceiver unit, and a speaker. A light bulb can be assembled on the light bulb holder. The wireless transceiver unit wirelessly receives an external control signal and transmits the received control signal to the control unit. The control unit controls the first electronic switch or the second electronic switch to be turned on or turned off according to the content of the control signal, thus lightening or extinguishing the light bulb or turning on or turning off the speaker. In addition, the wireless transceiver unit further receives external audio signals and the received audio signals are transmitted to the control unit to be processed and then the processed audio signals are played by the speaker.

The better effectiveness of the present disclosure is described as follows. The light bulb holder module is connected between the light bulb slot and the light bulb. Also, the electronic switch inside the light bulb holder module can be turned on or turned off by wireless signals, thus lightening or extinguishing the light bulb or turning on or turning off the speaker. In addition, the wireless transceiver unit is built in the light bulb holder module. The light bulb holder module can wirelessly receive the external audio signals and the received audio signals are played by the speaker.

In addition, the light bulb holder module can provide a built-in memory unit for storing audio files. Hence, the light bulb holder module can decode and play the audio files without relying on any external electronic device when the control unit inside the light bulb holder module.

Accordingly, the speaker can be placed on the optimal location when the light bulb holder module is embedded into the light bulb on the ceiling so that users can obtain the best audio quality by the speaker built in the light bulb holder module.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1A is a schematic view of before embedding a light bulb holder module according to a preferred embodiment of the present disclosure;

FIG. 1B is a schematic view of after embedding the light bulb holder module according to the preferred embodiment of the present disclosure;

FIG. 2 is a circuit block diagram of the light bulb holder module according to a preferred embodiment of the present disclosure;

FIG. 3 is a circuit block diagram of the light bulb holder module according to another preferred embodiment of the present disclosure;

FIG. 4 is a circuit block diagram of the light bulb holder module according to further another preferred embodiment of the present disclosure; and

FIG. 5 is a schematic view of after embedding the light bulb holder module according to another preferred embodiment of the present disclosure.

### DETAILED DESCRIPTION

Reference will now be made to the drawing figures to describe the present invention in detail.

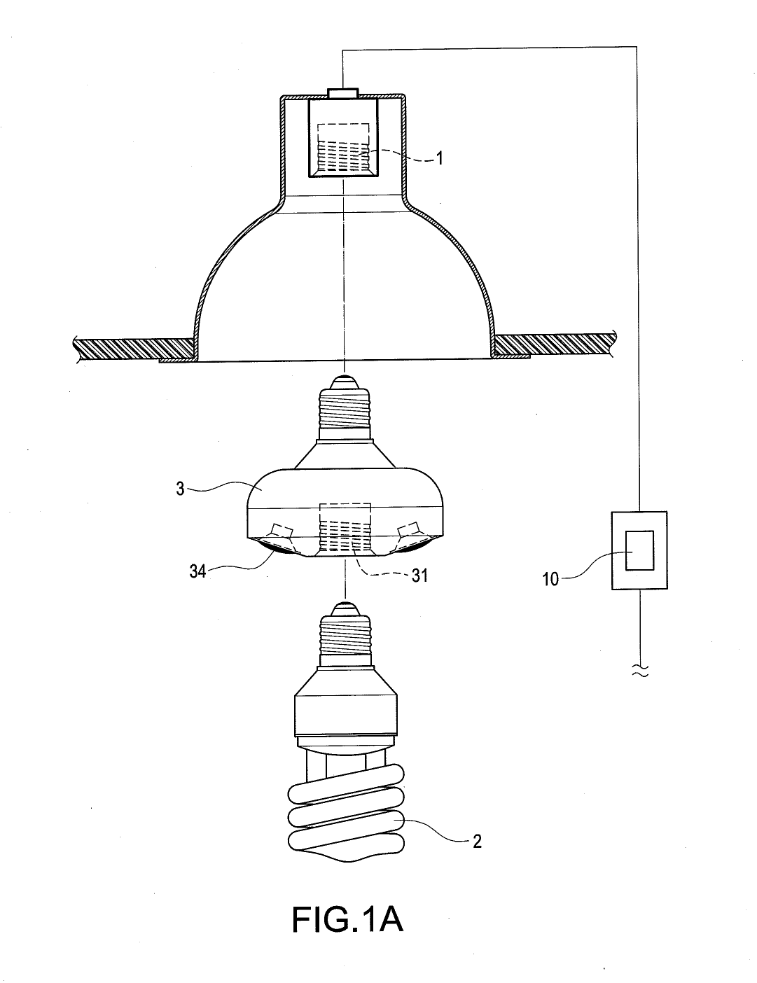

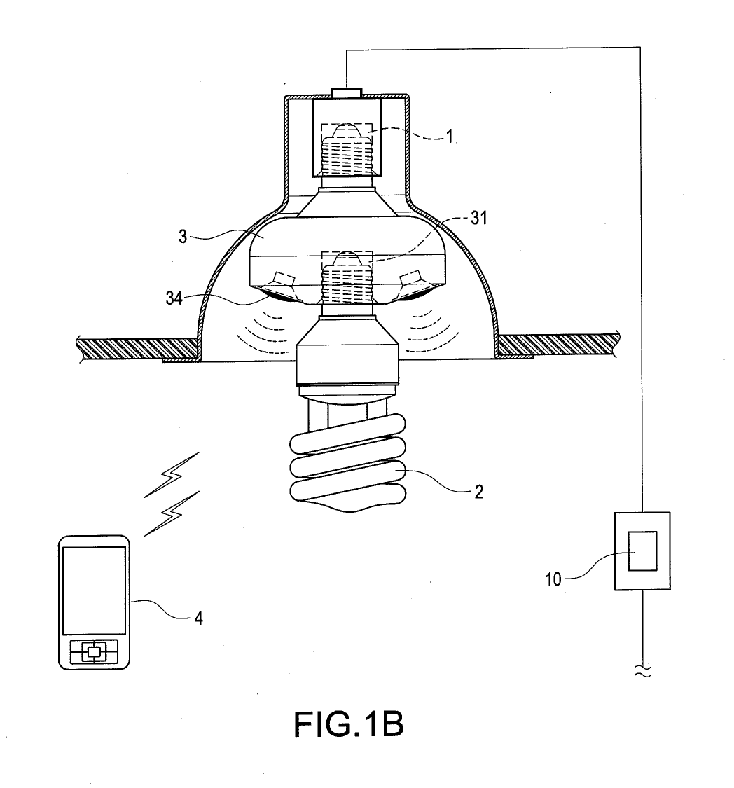

Reference is made to FIG. 1A and FIG. 1B which are a schematic view of before embedding and after embedding a light bulb holder module according to a preferred embodiment of the present disclosure. In general, the retained electric lines of configuring lamps are usually buried in the ceiling of a building. Hence, a light bulb 2 is installed on a light bulb slot 1 (or a light bulb holder) to be supplied via a utility power.

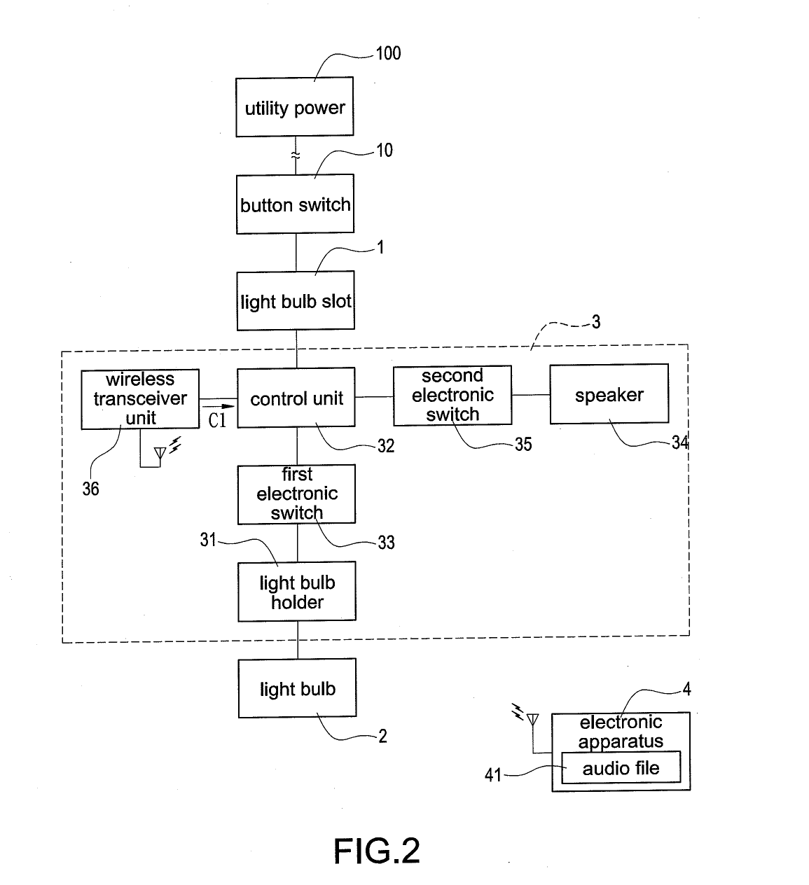

A light bulb holder module 3 with a function of sharing wireless network is embedded into a light bulb slot 1 and also can be disassembled. The light bulb holder module 3 provides a light bulb holder 31 so that the light bulb 2 is installed on the light bulb holder 31 and electrically connected to a utility power 100 (as shown in FIG. 2) to be supplied power via light bulb holder module 3 after the light bulb holder module 3 is embedded into the light bulb slot 1.

The utility power 100 is connected to the light bulb slot 1 via a button switch 10. When the button switch 10 is turned on, the light bulb holder module 3 can receive electricity via the light bulb slot 1 to lighten the light bulb 2. On the contrary, the light bulb holder module 3 cannot receive electricity so that the light bulb 2 is extinguished when the button switch 10 is turned off.

As mentioned above, the light bulb 2 is electrically connected to the light bulb slot 1 via the light bulb holder module 3, thus receiving electricity from the utility power 100. More specifically, the light bulb 2 is connected to a light bulb holder 31 at a bottom of the light bulb holder module 3 and then the light bulb 2 is connected to the light bulb slot 1 via a control unit and a first electronic switch (such as the control unit 32 and the first electronic switch 33 shown in FIG. 2) inside the light bulb holder module 3. In this embodiment, the light bulb holder module 3 can receive an external control signal (such as the control signal C1 shown in FIG. 2) and the content of the control signal C1 is provided to operate and control the first electronic switch 33, thus lightening or extinguishing the light bulb 2. In this embodiment, the control signal C1 is transmitted from an electronic apparatus 4, such as a remote controller, a personal digital assistant (PDA), a smart phone, or a tablet computer to operate and control the light bulb 2. However, the embodiments are only exemplified but are not intended to limit the scope of the disclosure.

Especially, the least affected from obstructions in a residential location is the ceiling. Hence, the light bulb slot 1 and the light bulb 2 are usually installed on the ceiling. In this embodiment, the light bulb holder module 3 is used to connect to the light bulb slot 1 and the light bulb 2, thus lightening or extinguishing the light bulb 2 by using a wireless scheme via the control signal C1. Furthermore, a speaker 34 is built in the light bulb holder module 3. The light bulb holder module 3 can receive audio signals wirelessly transmitted from the electronic apparatus 4 and the audio signals are played by the speaker 34. Accordingly, the speaker 34 can be placed on the optimal location (namely, the ceiling) so that users can obtain the best audio quality by the speaker 34 built in the light bulb holder module 3.

Reference is made to FIG. 2 which is a circuit block diagram of the light bulb holder module according to a preferred embodiment of the present disclosure. The light bulb holder module 3 mainly includes the light bulb holder 31, the control unit 32, the first electronic switch 33, the speaker 34, a second electronic switch 35, and a wireless transceiver unit 36. The control unit 32 is electrically connected to the first electronic switch 33, the second electronic switch 35, and the wireless transceiver unit 36 to receive, transmit, and handle signals. The first electronic switch 33 is electrically connected between the control unit 32 and the light bulb holder 31. In this embodiment, the first electronic switch 33 can be a relay. The first electronic switch 33 is controlled by the control unit 32 to be turned on or turned off, thus changing statuses of the light bulb holder 31.

The wireless transceiver unit 36 wirelessly receives the control signal C1 outputted from the electronic apparatus 4 and then the received control signal C1 is transmitted to the control unit 32. When the content of the control signal C1 is a command of switching control the light bulb 2, the first electronic switch 33 is controlled to be turned on or turned off according to the content of the first control signal C1. Moreover, when the content of the control signal C1 is a command of switching control the speaker 34, the second electronic switch 35 is controlled to be turned on or turned off according to the content of the control signal C1, thus turning on or turning off the speaker 34. In this embodiment, the second electronic switch 35 can be a relay. However, the embodiment is only exemplified but is not intended to limit the scope of the disclosure. The electronic apparatus 4 stores at least one audio file 41 therein. Also, the electronic apparatus 4 has capability of executing and decoding the audio file 41. The electronic apparatus executes the audio file 41 and produces an audio signal. In particular, the produced audio signal is wirelessly transmitted. Therefore, the wireless transceiver unit 36 receives the audio signal transmitted from the electronic apparatus 4 and then the received audio signal is transmitted to the control unit 32 to be processed.

In this embodiment, the wireless transceiver unit 36 can be a Bluetooth transmission unit or an infrared transmission unit and the control signal C1 can be a Bluetooth control signal or an infrared transmission signal. The control signal C1 is transmitted between the electronic apparatus 4 and the light bulb holder module 3 via the Bluetooth transmission interface or the infrared transmission interface. In addition, the audio signal is a Bluetooth transmission signal and the audio signal is transmitted by the electronic apparatus 4 via the Bluetooth transmission unit. However, the embodiments are only exemplified but are not intended to limit the scope of the disclosure. More specifically, the light bulb holder module 3 can provide a plurality of wireless transceiver units 36 and the wireless transceiver units 36 can receive the control signal C1 and the audio signal via the Bluetooth transmission interface or the infrared transmission interface.

As mentioned above, users can operate and control the electronic apparatus 4 to control the light bulb 2 and the speaker 34 of the light bulb holder module 3. In addition, at least one audio file 41 in the electronic apparatus 4 is selected and executed to produce audio signals. The produced audio signals are transmitted to the light bulb holder module 3 to be played via the speaker 34.

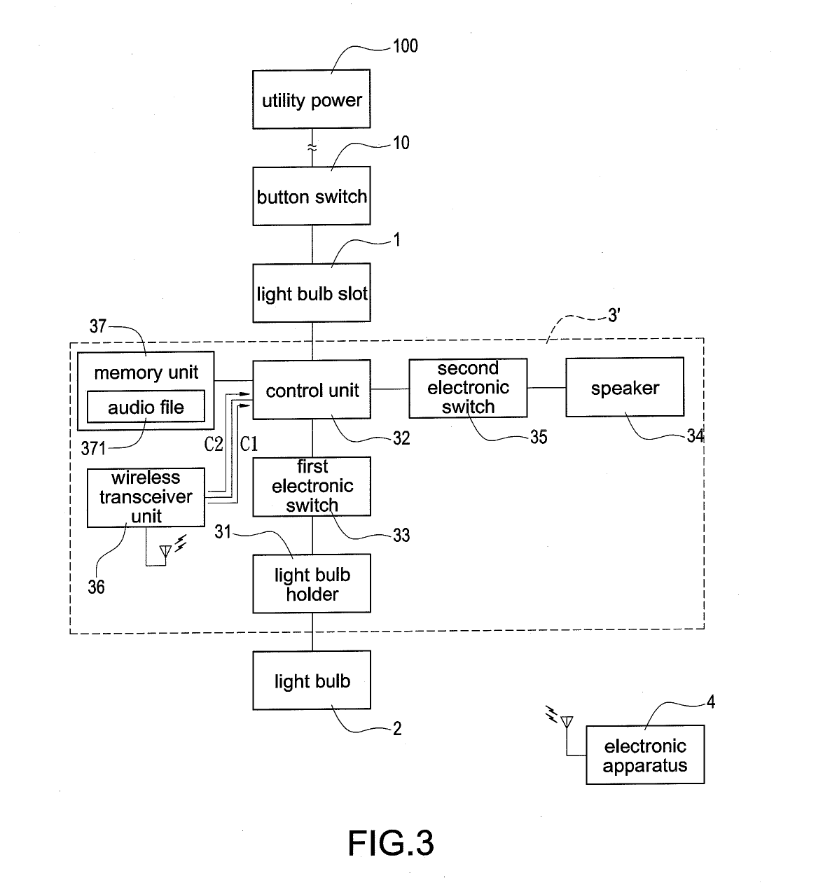

Reference is made to FIG. 3 which is a circuit block diagram of the light bulb holder module according to another preferred embodiment of the present disclosure. In this embodiment, a light bulb holder module 3′ is disclosed. The light bulb holder module 3′ has the light bulb holder 31, the control unit 32, the first electronic switch 33, the speaker 34, the second electronic switch 35, the wireless transceiver unit 36, and a memory unit 37. In this embodiment, at least one audio file 371 is stored in the memory unit 37. Note that, the control unit 32 can provide capability of executing and decoding audio files. Hence, the control unit 32 can directly read any one audio file 371 stored in the memory unit 37 and execute and decode the read audio file.

In addition, the control unit 32 transmits the decoded audio file to the speaker 34 to be played. As a result, the audio files can be directly processed by the light bulb holder module 3′ without being provided, executed, and transmitted by the electronic apparatus 4 (as the audio files 41 shown in FIG. 2) and also the audio signals transmitted from the electronic apparatus 4 cannot be received.

More specifically, in this embodiment, users can operate and control the electronic apparatus 4 to produce a second control signal C2. The light bulb holder module 3 wirelessly receives the second control signal C2 via the wireless transceiver unit 36 and the received second control signal C2 is transmitted to the control unit 32 to be processed. According to practical demands, users can operate and control the electronic apparatus 4 to produce the second control signal C2 so that the control unit 32 reads the corresponding audio files 371 stored in the memory unit 37 and executes the read audio files 371 according to the content of the second control signal C2.

In addition, users further operate and control the control unit 32 via the second control signal C2. Hence, the control unit 32 can control the read audio files 371 to be played, paused, stopped, and fast forwarded according to the content of the second control signal C2. That is, users can regard the light bulb holder module 3 as a wireless media player and regard the electronic apparatus 4 as a wireless controller. In this embodiment, the wireless transceiver unit 36 can be a Bluetooth transmission interface or an infrared transmission interface. Also, the first control signal C1 and the second control signal C2 can be a Bluetooth transmission signal or an infrared transmission signal. However, the embodiments are only exemplified but are not intended to limit the scope of the disclosure.

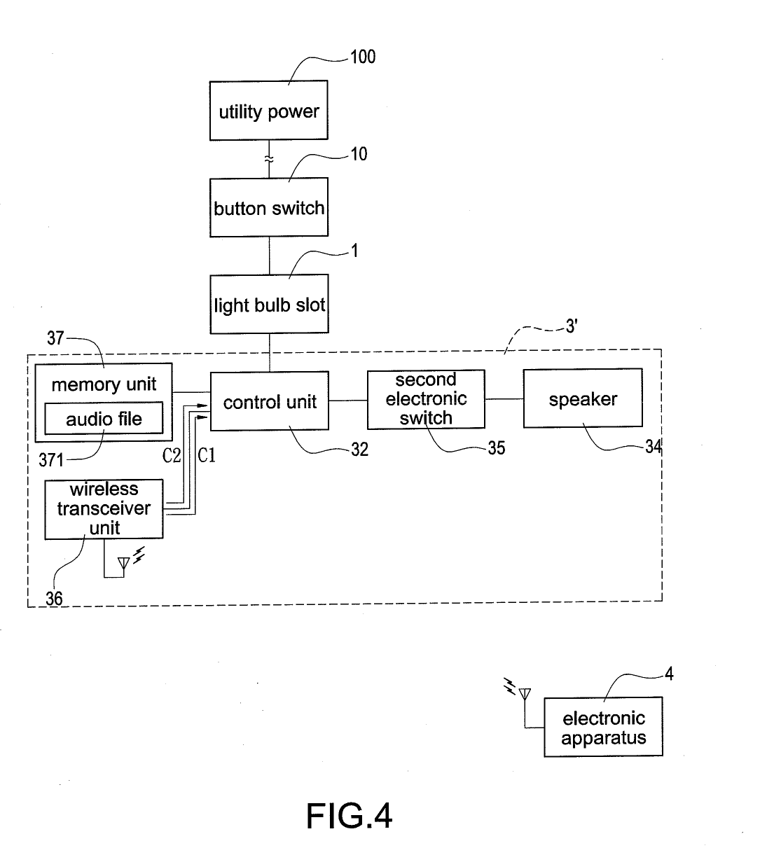

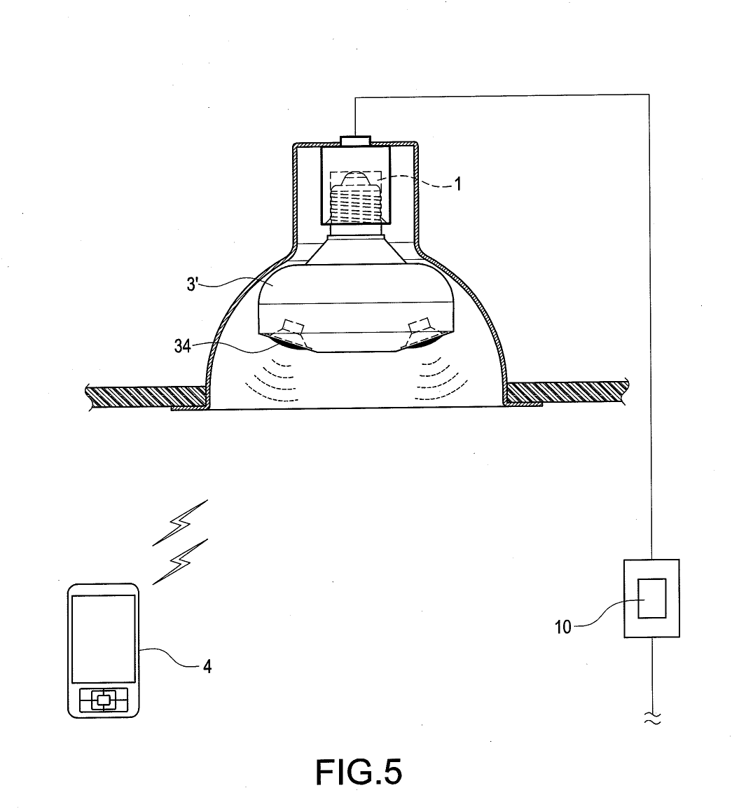

Finally, reference is made to FIG. 4 and FIG. 5 which are a circuit block diagram of the light bulb holder module and a schematic view of after embedding the light bulb holder module according to another preferred embodiment of the present disclosure. In this embodiment, the light bulb holder module 3′ does not need to have the first electronic switch 33 and the light bulb holder 31. That is, the light bulb holder module 3′ is a pure speaker module. The light bulb holder module 3′ is installed on the light bulb slot 1 and is supplied power via the light bulb slot 1. In the embodiment, the light bulb holder module 3′ has the control unit 32, the speaker 34, the second electronic switch 35, the wireless transceiver unit 36, and the memory unit 37 therein. In particular, at least one audio file 371 is stored in the memory unit 37. Note that, the control unit 32 can provide capability of executing and decoding audio files.

The light bulb holder module 3′ is installed on the light bulb slot 1. The control unit 32 receives the utility power 100 via the light bulb slot 1 to supply power to the speaker 34. Users can operate and control the electronic apparatus 4 to provide the first control signal C1 and the second control signal C2. In particular, the first control signal C1 is provided to control the second electronic switch 35 to turn on or turn off the speaker 34. The second control signal C2 is provided to control the control unit 32 to read the audio files 371 stored in the memory unit 37 and then the control unit 32 can execute and decode the read audio file 371. Finally, the control unit 32 transmits the decoded audio file 371 to the speaker 34 to be played.

In addition, users further operate and control the control unit 32 via the second control signal C2. Hence, the control unit 32 can control the read audio files 371 to be played, paused, stopped, and fast forwarded according to the content of the second control signal C2. In this embodiment, the wireless transceiver unit 36 can be a Bluetooth transmission interface or an infrared transmission interface. Also, the first control signal C1 and the second control signal C2 can be a Bluetooth transmission signal or an infrared transmission signal. However, the embodiments are only exemplified but are not intended to limit the scope of the disclosure.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A light bulb holder module with a built-in speaker embedded into a light bulb slot, the light bulb holder module comprising:
a control unit electrically connected to the light bulb slot and configured to receive electricity produced from a utility power;
a first electronic switch electrically connected to the control unit;
a light bulb holder electrically connected to the first electronic switch, wherein the light bulb holder module is connected to an external light bulb via the light bulb holder and the light bulb receives electricity via the light bulb holder module;
a speaker;
a second electronic switch electrically connected to the control unit and the speaker; and
a wireless transceiver unit electrically connected to the control unit and configured to receive an external control signal and transmit the received control signal to the control unit to be processed, wherein the control unit is configured to control the first electronic switch or the second electronic switch to be turned on or turned off according to the content of the control signal, thus lightening or extinguishing the light bulb or turning on or turning off the speaker;
wherein the wireless transceiver unit further receives an external audio signal and the received audio signal is transmitted to the control unit to be processed so that the control unit transmits the processed audio signal to the speaker to be played.

2. The light bulb holder module in claim 1, wherein the first electronic switch and the second electronic switch are relays.

3. The light bulb holder module in claim 1, wherein the wireless transceiver unit is a Bluetooth transmission unit, the control signal is a Bluetooth control signal, and the audio signal is a Bluetooth transmission signal.

4. The light bulb holder module in claim 1, wherein the wireless transceiver unit is an infrared transmission unit and the control signal is an infrared transmission signal.

5. A light bulb holder module with a built-in speaker embedded into a light bulb slot, the light bulb holder module comprising:
a control unit electrically connected to the light bulb slot and configured to receive electricity produced from a utility power and provide capability of executing and decoding audio files;
a speaker;
a first electronic switch electrically connected to the control unit and the speaker;
a wireless transceiver unit electrically connected to the control unit and configured to receive an external first control signal and transmit the received first control signal to the control unit to be processed, wherein the control unit is configured to control the first electronic switch to be turned on or turned off according to the content of the first control signal, thus turning on or turning off the speaker; and
a memory unit electrically connected to the control unit and configured to store at least one audio file;
wherein the control unit reads at least one audio file stored in the memory unit, executes and decodes the read audio file, and transmits the decoded audio file to the speaker to be played.

6. The light bulb holder module in claim 5, further comprising:
a second electronic switch electrically connected to the control unit; and
a light bulb holder electrically connected to the second electronic switch, wherein the light bulb holder module is connected to an external light bulb via the light bulb holder and the light bulb receives electricity via the light bulb holder module;
wherein the wireless transceiver unit is configured to receive the first control signal and transmit the received first control signal to the control unit to be processed, the control unit is configured to control the second electronic switch to be turned on or turned off according to the content of the first control signal, thus lightening or extinguishing the light bulb.

7. The light bulb holder module in claim 6, wherein the first electronic switch and the second electronic switch are relays.

8. The light bulb holder module in claim 5, wherein the wireless transceiver unit is configured to wirelessly receive an external second control signal, the control unit is configured to read and execute the corresponding audio files stored in the memory unit according to the content of the second control signal.

9. The light bulb holder module in claim 8, wherein the control unit is configured to control the read audio files to be played, paused, stopped, and fast forwarded according to the second control signal.

10. The light bulb holder module in claim 9, wherein the wireless transceiver unit is a Bluetooth transmission unit or an infrared transmission unit, the first control signal and the second control signal are a Bluetooth control signal or an infrared control signal.
